(19) United States
(12) Patent Application Publication
(10) Pub. No.: US 2022/0338407 A1
(43) Pub. Date: Oct. 27, 2022

(54) FERTILISER BOOT AND SHIELD

(71) Applicant: Ausplow Pty. Ltd., Cockburn Central (AU)

(72) Inventor: John William Ryan, Cockburn Central (AU)

(21) Appl. No.: 17/725,727

(22) Filed: Apr. 21, 2022

(30) Foreign Application Priority Data
Apr. 23, 2021 (AU) AU2021901211
Aug. 25, 2021 (AU) AU2021221571
Feb. 14, 2022 (AU) AU2022200972

(51) Int. Cl. A01C 15/00; A01C 23/02

(52) U.S. Cl. CPC A01C 15/00; A01C 23/023

(57) ABSTRACT

A fertilizer boot (10) for a plough assembly (27) including a body (11) with an upper solid fertiliser inlet (12) and a lower solid fertiliser outlet (14) and a passageway between the upper solid fertiliser inlet (12) and the lower solid fertiliser outlet (14), wherein the body (11) has a lower body portion (31) that includes the lower solid fertiliser outlet (14), the lower body portion (31) having outwardly facing sidewalls (33) on either side of the lower solid fertiliser outlet (14), and wherein the sidewalls (33) are at least partially coated with a wear-resistant coating for reduction of wear of the sidewall (33) during use of the fertiliser boot (10) with the plough assembly (27).

### REFERENCE TO EARLIER APPLICATIONS

The present application claims the benefit of Australian Provisional Patent Application No. 2021901211 and Australian Patent Application No. 2021221571, the contents of which are included herein in their entirety by reference thereto.

### FIELD

The present invention relates to a fertiliser boot and shield used with a plough assemblies.

### BACKGROUND

Ploughs with fertiliser boots and seeding assemblies are well known. It is common for condensation to accumulate around the fertiliser delivery lines in the fertiliser boot. Where condensation accumulates fertiliser delivered to the fertiliser boot can accumulate, causing potential blockages, corrosion, and other issues. A further limitation in existing fertiliser boots is that they are designed to only provide the supply of fertiliser through a single liquid fertilizer delivery.

To address the above noted fertiliser accumulation problem caused by condensation existing approaches include heating the delivery system to prevent moisture accumulation in the system. This approach used additional devices that present an additional failure point in the system. Other existing approaches include using solid plastic or cast or solid metal fertilizer boots. These solid boots provide interfaces that allow the ingress of moisture.

A further problem exists that the outwardly facing surfaces of fertiliser boots are subject to wear and tear of soil being worked by the seeding assembly.

### SUMMARY

It is an object of the present invention to at least substantially address one or more of the above disadvantages, or at least provide a useful alternative to the above discussed devices.

In a first aspect the present invention provides a fertilizer boot for a plough assembly including a body with an upper solid fertiliser inlet and a lower solid fertiliser outlet and a passageway between the upper solid fertiliser inlet and the lower solid fertiliser outlet,

wherein the body has a lower body portion that includes the lower solid fertiliser outlet, the lower body portion having outwardly facing sidewalls on either side of the lower solid fertiliser outlet, and

wherein the sidewalls are coated with a wear-resistant coating for reduction of wear of the sidewall during use of the fertiliser boot with the plough assembly.

Preferably, the lower body portion includes outwardly facing forward and rearward surface that are coated with the wear-resistant coating.

Preferably, the wear-resistant coating includes a silicon ceramic material.

Preferably, the wear-resistant coating includes alumina ceramic material.

Preferably, the wear-resistant coating is a composite of 9 wt % epoxy and 91 wt % alumina ceramic chips.

Preferably, the body has an upper body portion above the lower body portion, and wherein the upper body portion includes outwardly facing surfaces that are coated with a second wear-resistant coating.

Preferably, the second wear-resistant coating includes a powder coating including at least 10-30 wt % barium sulfate and 10 wt % titanium dioxide.

Preferably, the second wear-resistant coating has a film thickness of between 40-60 μm.

Preferably, a resilient grommet is arranged to be placed within the passageway to receive a solid fertiliser delivery tube and create a seal between the solid fertilizer delivery tube and the passageway.

Preferably, the fertiliser boot includes a plurality of liquid delivery tubes and a plurality of liquid delivery tube passageways arranged to receive the plurality of liquid delivery tubes.

Preferably, the plurality of liquid delivery tube passageways include an outlet at the base of the fertiliser boot.

Preferably, the fertiliser boot includes liquid delivery tube guides along the body.

Preferably, the resilient grommet covers the internal surface of the passageway.

Preferably, the fertiliser boot includes an attachment bracket arranged to connect the fertiliser boot to a digging assembly of the plough assembly.

Preferably, attachment bracket includes the delivery tube guides.

Preferably, the fertiliser boot includes a spacer that spaces the fertiliser boot from the digging assembly.

Preferably, the outlets arranged with respect to the plough assembly to provide deep banding of liquid fertiliser in use.

Preferably, the resilient grommet is made of rubber.

In a second aspect, the present invention provides a fertiliser boot for a plough assembly including a body with an upper solid fertiliser inlet and a lower solid fertiliser outlet and a passageway between the upper solid fertiliser inlet and the lower solid fertiliser outlet,

wherein the fertiliser boot has a boot aperture and includes a bracket having a first bracket aperture and a second bracket aperture, such that the fertiliser boot is attachable to the plough assembly by connection of a first fastener through the boot aperture and the first bracket aperture, and connection of a second fastener through the second aperture an aperture on the plough assembly,

wherein the bracket has multiple first apertures, such that the fertiliser boot is attachable to the plough assembly in two or more positions that are vertically displaced from each other.

Preferably, the first bracket aperture and the second bracket aperture are oriented perpendicularly to each other.

Preferably, the two or more positions of the fertiliser boot result in a lowermost extension of the fertiliser boot between 70 to 120 mm below a top level of soil being worked by the plough assembly to which the fertiliser boot is attachable.

In a third aspect, the present invention provides a fertilizer boot for a plough assembly including a body with an upper solid fertiliser inlet and a lower solid fertiliser outlet and a passageway between the upper solid fertiliser inlet and the lower solid fertiliser outlet, wherein a resilient grommet is arranged to be placed within the passageway to receive a solid fertiliser delivery tube and create a seal between the solid fertilizer delivery tube and the passageway.

### BRIEF DESCRIPTION OF THE DRAWINGS

Preferred embodiments of the present invention will now be described by way of example, with reference to the accompanying drawings, wherein:

FIG. 1 is a side view of a fertiliser delivery boot according to an embodiment of the present invention.

FIG. 2 is a rear view of the fertiliser boot of FIG. 1.

FIG. 3 is a front view of the fertiliser booth of FIG. 1.

FIG. 4 is a partial perspective view of the fertiliser boot of FIG. 1.

FIG. 5 is a perspective view of the fertiliser boot of FIG. 1.

FIG. 6 is an exploded view of the fertiliser boot of FIG. 1.

FIG. 7 is a sideview of the fertiliser boot of FIG. 1 in a first position.

FIG. 8 is a sideview of the fertiliser boot of FIG. 1 in a second position.

### DETAILED DESCRIPTION

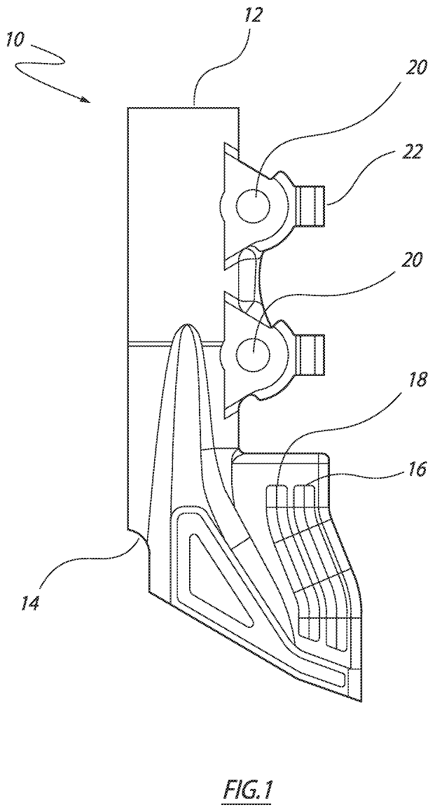

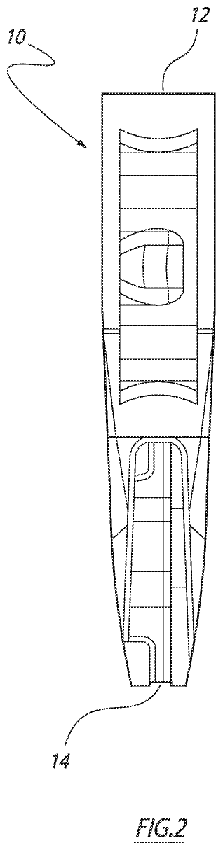

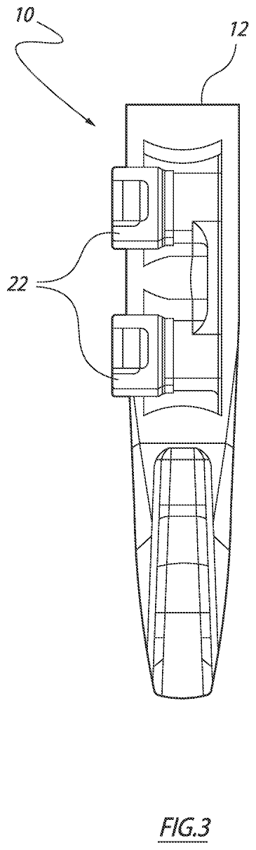

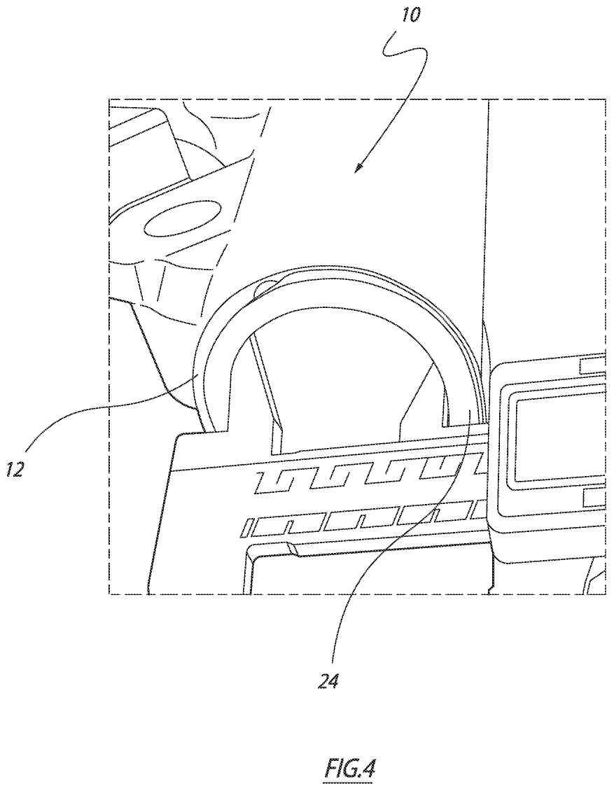

With reference to FIGS. 1 to 8, there is disclosed herein a fertiliser boot 10 to be used with a plough assembly 27. The fertiliser boot 10 is includes a resilient grommet 24 at the solid fertiliser inlet 12 of the fertiliser boot and provides a plurality of liquid fertiliser passageways 13 for delivery of liquid fertiliser from outlets 17.

In one embodiment of the present invention the resilient grommet is made of rubber.

The fertiliser boot includes a body 11, that in one embodiment is attached to the rear of the digging assembly 25. Attachment bracket 22 is fixed to the digging assembly 25 and the fertiliser boot 10 via fixing means, such as bolts, passing through apertures 20. A passageway extends between the fertiliser inlet 12 and a solid fertiliser outlet 14 to receive and transfer solid fertiliser.

Solid fertiliser delivery tube 21 extends downwardly into the passageway between fertiliser boot at end 12 and solid fertiliser boot outlet 14 and supplies solid fertiliser to be delivered via outlet 14 at the base of the body 11 of the fertiliser boot. In one embodiment the solid fertiliser is granular fertiliser. Moulded resilient grommet 24 fits in the aperture in the top 12 of the fertiliser boot 10 to create a seal between the delivery tube 21 and internal surface of passageway extending between the end 12 and outlet 14. The seal stops the ingress of liquid into the passageway and stops liquid mixing with solid fertiliser delivered into the passageway.

The front of fertiliser boot 10 includes a first passageway 18 and a second passageway 16 each arranged to receive one of a plurality of liquid fertiliser delivery tubes 13 and deliver liquid fertiliser via liquid fertiliser outlets 17 at the base of the fertiliser boot 10. Attachment bracket 22 includes guides 15 to guide the plurality of liquid fertiliser delivery tubes 13 along the body 11 of the fertiliser boot 10 towards the first and second passageways 18, 16. The plurality of liquid fertiliser delivery tubes 13 allows different liquid fertilisers to be delivered to a trough formed by the digging assembly 25 in a deep banded arrangement. This avoids mixing of different liquids that travel through liquid delivery passageways.

In one arrangement, the moulded rubber grommet 24 has a profile that lines the entire inner passageway between inlet 12 and outlet 14 of the fertiliser boot 10. In an alternative embodiment, the moulded rubber grommet extends partially into the passageway between the inlet 12 and the outlet 14 of the fertiliser boot 10.

The fertilizer is delivered to a position behind the blade assembly 25.

Forward of the boot 10 is a shield 15 that is spaced the boot 10 from the digging assembly 25. Essentially the boot 10 is located behind the shield 15. The shield 15 and is secured to the shield 15 by means of the fixing means such as bolts through attachment bracket 22.

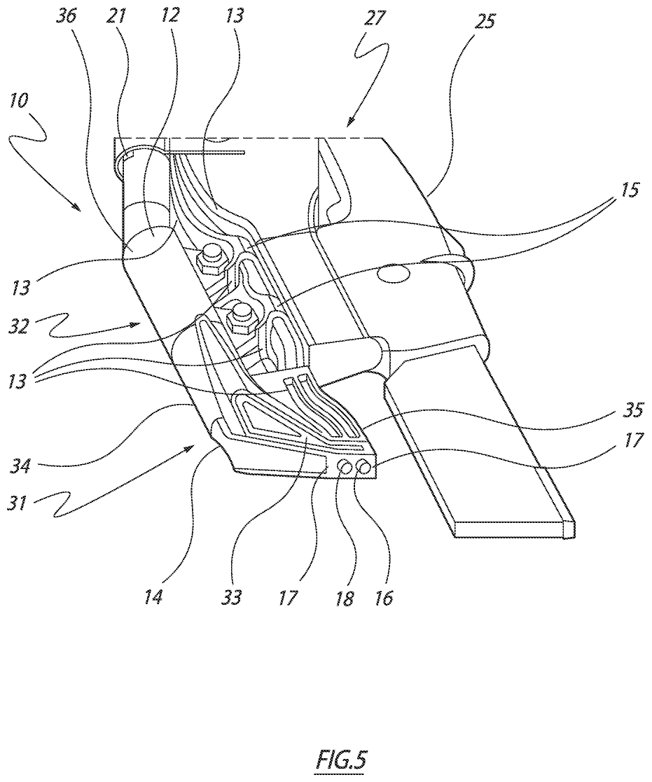

As shown in FIG. 5, in another embodiment, the body 11 of the boot 10 has a lower body portion 31. The lower body portion 31 includes the lower solid fertiliser outlet 14 and typically extends, in use, below a top level of the soil being worked by the plough assembly 27 with which the boot 10 is being used. The lower body portion 31 includes outwardly facing sidewalls 33 on either side of the lower solid fertiliser outlet 14. In use, the sidewalls 33 deflect soil being worked. The sidewalls 33 are coated at least partially, or alternatively wholly, with a wear-resistant coating for reduction of wear of the respective sidewall 33 during use of the boot 10 with the plough assembly 27.

The lower body portion 31 may also include outwardly facing rearward 34 and forward 35 surfaces. Typically, the rearward surface 34 receives less wear than the sidewalls 33 since the rearward surface 34 faces in the opposite direction from the direction the plough assembly 27 moves during use. Similarly typically, the forward surface 35 receives less wear than the sidewalls 33, since the forward surface 35 immediately follows the digging assembly 25, which reduces the severity of soil impact on the forward surface 35. Nonetheless, the rearward surface 34 and forward surface 35 may be coated with the wear-resistant coating.

The wear-resistant coating may include a silicon ceramic material. The wear-resistant coating may also, or instead, include an alumina ceramic material. Preferably, the wear-resistant coating is a composite of 9 wt % epoxy and 91 wt % alumina ceramic chips.

The body 10 may also have an upper body portion 32 above the lower body portion 31. In use, the upper body portion 32 extends above the top level of the soil being worked by the plough assembly 27. The upper body portion 32 includes outwardly facing surfaces 36 that are at least partially, or alternatively wholly, coated with a second wear-resistant coating. The second wear-resistant coating may include a powder coating including 10-30 wt % barium sulfate and about 10 wt % titanium dioxide. Preferably, the second wear-resistant coating has a film thickness of between 40 to 60 μm.

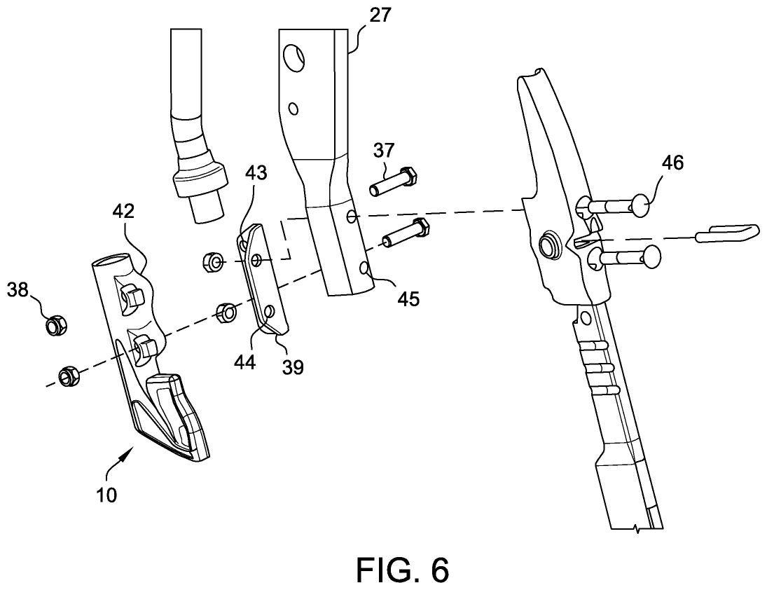

Referring now to FIG. 6, in another embodiment the boot 10 may have a boot aperture 42. The boot 10 also includes a bracket 39, preferably having two perpendicular arms. The bracket 39 includes a first bracket aperture 43 and a second bracket aperture 44. The boot 10 is attachable to the bracket 39 by connection of a first fastener 37, such as a bolt and nut combination, through the boot aperture 42 and the first bracket aperture 43. The bracket 39 is attachable to the plough assembly 27 by connection of a second fastener 46, such as a bolt and nut combination, through the second bracket aperture 44 and an aperture on the plough assembly.

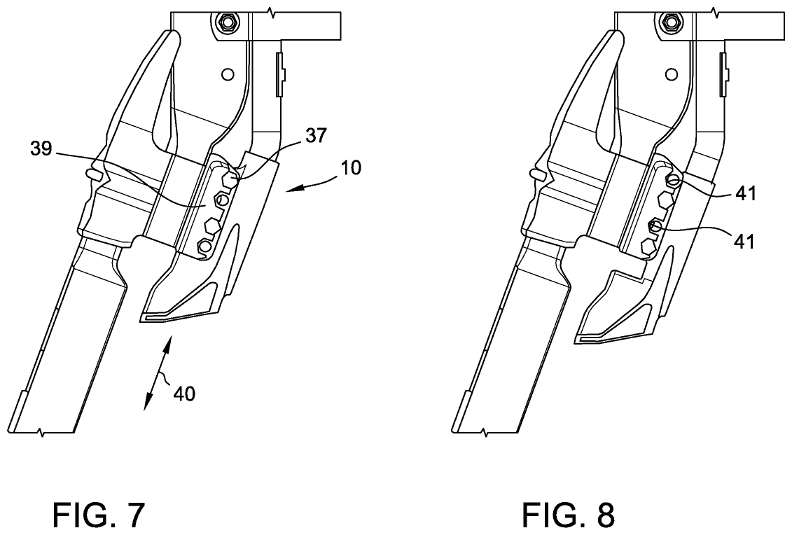

As seen in FIGS. 7 and 8, the bracket 39 has multiple first apertures 43, such that the fertiliser boot 10 is attachable to the plough assembly 27 in two or more positions that are vertically displaced from each other. Preferably, two fasteners 37 are used to attach the boot 10 to the bracket 39, and two fasteners 46 are used to attach the bracket 39 to the plough assembly 27.

As seen in FIG. 6, the first bracket aperture 43 and the second bracket aperture 44 are oriented perpendicularly to each other. Additionally, the two or more positions of the fertiliser boot 10 result in a lowermost extension of the fertiliser boot 10 between 70 mm to 120 mm below a top level of soil being worked by the plough assembly to which the fertiliser boot 10 is attachable.

1. A fertilizer boot for a plough assembly including a body with an upper solid fertiliser inlet and a lower solid fertiliser outlet and a passageway between the upper solid fertiliser inlet and the lower solid fertiliser outlet,
wherein the body has a lower body portion that includes the lower solid fertiliser outlet, the lower body portion having outwardly facing sidewalls on either side of the lower solid fertiliser outlet, and
wherein the sidewalls are at least partially coated with a wear-resistant coating for reduction of wear of the sidewall during use of the fertiliser boot with the plough assembly.

2. The fertiliser boot of claim 1, wherein the lower body portion includes outwardly facing forward and rearward surface that are coated with the wear-resistant coating.

3. The fertiliser boot of claim 1, wherein the wear-resistant coating includes a silicon ceramic material.

4. The fertiliser boot of claim 1, wherein the wear-resistant coating includes alumina ceramic material.

5. The fertiliser boot of claim 4, wherein the wear-resistant coating is a composite of 9 wt % epoxy and 91 wt % alumina ceramic chips.

6. The fertiliser boot of claim 1, wherein the body has an upper body portion above the lower body portion, and
wherein the upper body portion includes outwardly facing surfaces that are at least partially coated with a second wear-resistant coating.

7. The fertiliser boot of claim 6, wherein the second wear-resistant coating includes a powder coating including 10-30 wt % barium sulfate and about 10 wt % titanium dioxide.

8. The fertiliser boot of claim 6, wherein the second wear-resistant coating has a film thickness of between 40-60 μm.

9. The fertiliser boot of claim 1 wherein a resilient grommet is arranged to be placed within the passageway to receive a solid fertiliser delivery tube and create a seal between the solid fertilizer delivery tube and the passageway.

10. The fertiliser boot of claim 9, including a plurality of liquid delivery tubes and a plurality of liquid delivery tube passageways arranged to receive the plurality of liquid delivery tubes.

11. The fertiliser boot of claim 10, wherein the plurality of liquid delivery tube passageways include an outlet at the base of the fertiliser boot.

12. The fertiliser boot of claim 10 including liquid delivery tube guides along the body.

13. The fertiliser boot of claim 9, wherein the resilient grommet covers the internal surface of the passageway.

14. The fertiliser boot of claim 9, including an attachment bracket arranged to connect the fertiliser boot to a digging assembly of the plough assembly.

15. The fertiliser boot of claim 14 when appended to claim 12, wherein the attachment bracket includes the delivery tube guides.

16. The fertiliser boot of claim 14 including a spacer that spaces the fertiliser boot from the digging assembly.

17. The fertiliser boot assembly of claim 11, wherein the outlets arranged with respect to the plough assembly to provide deep banding of liquid fertiliser in use.

18. The fertiliser boot assembly of claim 9, wherein the resilient grommet is made of rubber.

19. A fertiliser boot for a plough assembly including a body with an upper solid fertiliser inlet and a lower solid fertiliser outlet and a passageway between the upper solid fertiliser inlet and the lower solid fertiliser outlet,
wherein the fertiliser boot has a boot aperture and includes a bracket having a first bracket aperture and a second bracket aperture, such that the fertiliser boot is attachable to the plough assembly by connection of a first fastener through the boot aperture and the first bracket aperture, and connection of a second fastener through the second aperture an aperture on the plough assembly,
wherein the bracket has multiple first apertures, such that the fertiliser boot is attachable to the plough assembly in two or more positions that are vertically displaced from each other.

20. The fertiliser boot of claim 19, wherein the first bracket aperture and the second bracket aperture are oriented perpendicularly to each other.

21. The fertiliser boot of claim 19, wherein the two or more positions of the fertiliser boot result in a lowermost extension of the fertiliser boot between 70 to 120 mm below a top level of soil being worked by the plough assembly to which the fertiliser boot is attachable.

22. A fertilizer boot for a plough assembly including a body with an upper solid fertiliser inlet and a lower solid fertiliser outlet and a passageway between the upper solid fertiliser inlet and the lower solid fertiliser outlet, wherein a resilient grommet is arranged to be placed within the passageway to receive a solid fertiliser delivery tube and create a seal between the solid fertilizer delivery tube and the passageway.

23. The fertiliser boot for a plough assembly as claimed in claim 22, including a plurality of liquid delivery tubes and a plurality of liquid delivery tube passageways arranged to receive the plurality of liquid delivery tubes.

24. The fertiliser boot for a plough assembly as claimed in claim 23, wherein the plurality of liquid delivery tube passageways include an outlet at the base of the fertiliser boot.

25. The fertiliser boot for a plough assembly as claimed in claim 23, including liquid delivery tube guides along the body.

26. The fertiliser boot for a plough assembly as claimed in claim 22, wherein the resilient grommet covers the internal surface of the passageway.

27. The fertiliser boot for a plough assembly as claimed in claim 22, including an attachment bracket arranged to connect the fertiliser boot to a digging assembly of the plough assembly.

28. The fertiliser boot for a plough assembly as claimed in claim 27, wherein the attachment bracket includes liquid delivery tube guides along the body.

29. The fertiliser boot for a plough assembly as claimed in claim 27 including a spacer that spaces the fertiliser boot from the digging assembly.

30. The fertiliser boot assembly for a plough assembly as claimed in claim 24, wherein the outlets arranged with respect to the plough assembly to provide deep banding of liquid fertiliser in use.
